(19) United States
(12) Patent Application Publication
(10) Pub. No.: US 2003/0057365 A1
(43) Pub. Date: Mar. 27, 2003

(54) Folded reflecting path optical spot scanning system

(76) Inventors: Ralph W. Bennett, Tallahassee, FL (US); Rober W. Mayer, Tallahassee, FL (US); Harold F. Qualls, Tallahassee, FL (US); Steven F. Bellenot, Tallahassee, FL (US)

Correspondence Address: J. WILEY HORTON, ESQUIRE, Pennington, Moore, Wilkinson, Bell & Dunbar, P.A., Post Office Box 10095, Tallahasse, FL, 32302-2095, US

(21) Appl. No.: 09/960,508

(22) Filed: Sep. 24, 2001

(51) Int. Cl. H01J 3/14; H01J 5/16

(52) U.S. Cl. 250/234

(57) ABSTRACT

A scanning device for measuring the distance between the scanning device and a plurality of surface points on a target object. The scanning device sweeps a laser beam and a line scan camera in synchronization up and down the surface of the target object. The line scan camera monitors the impact point of the laser beam upon the target object within its field of view. By knowing the position of the impact point within the camera's field of view, trigonometric principles can be applied to accurately calculate the distance to the impact point.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of optical scanning. More specifically, the invention comprises a device for projecting a laser beam on an object, indexing the laser beam across the object, and measuring the distance to the beam's point of impact on the object. The distance data collected may then be used to create a three-dimensional mathematical surface model of the object.

2. Description of the Related Art

Lasers have been used to measure distances for many years. The fact that they can very accurately measure such distances makes them ideal for scanning applications, where the laser is used to measure a set of distances in order to define the scanned object's shape. An example of one such device is disclosed in U.S. Pat. No. 5,414,268 to McGee (1995). The McGee device uses fifty-six fixed lasers to project points of coherent light on the object to be scanned. Half the lasers are positioned on one side of the object and half on the other. Twelve line scan cameras are mounted in the same plane as the lasers. These “look” for the points of coherent light on the scanned object. FIG. 5 of the McGee disclosure demonstrates the trigonometric principle by which a line scan camera can be used in conjunction with a coherent light source to measure distance. The '268 device can simultaneously measure the distance to 28 points on each side of the scanned object.

Mechanical means are used to move the object through the plane of the lasers and scanners. Thus, when the device is used in conjunction with means for data collection and analysis, an approximate surface model of the scanned object can be created.

While it does accomplish the desired result, the '268 device has several significant disadvantages. First, as discussed previously, it employs 56 lasers and 12 cameras. The expense of using this many lasers and cameras is considerable. Second, the device can only scan in one plane. Thus, mechanical actuation means are needed to move the object up and down through the scanning plane. The particular object disclosed in the '268 patent is a log. Log processing, like many industrial applications, involves objects moving at high speed along conveyor lines. The '268 device requires that the object be pulled off the moving line and subjected to a potentially lengthy scanning process. Given that log processing lines presently move at the rate of 300 to 400 feet per minute, this delay is a significant burden.

Some prior art devices are capable of scanning objects as they travel by at high speed. FIG. 1 illustrates one such device. Target object 10 is moving in the direction indicated. Laser 12 is fixed in position It projects coherent beam 14 in a direction which is orthogonal to target object 10's travel. Cylindrical lens 16 is placed in the path of coherent beam 14. It spreads coherent beam 14 into coherent plane 18. Coherent plane 18 intersects target object 10, thereby creating projected arc 20.

FIG. 2 shows the same device from a different perspective. The key to the device's function is the fact that the orientation of camera 22 is angularly offset from the orientation of laser 12 by offset angle 24. Camera 22 is a video camera having a fairly wide field of view, and capable of accurately detecting the intersection of projected arc 20 on target object 10 in two dimensions (commonly denoted as X and Y).

FIG. 3 shows the view looking at target object 10 through the lens of camera 22. Target object 10 moves in the direction indicated. Projected arc 20 is seen upon the surface of target object 10. Because of offset angle 24, camera 22 is viewing projected arc 20 out of the plane of coherent plane 18. Thus, the intersection of coherent plane 18 upon target 10 is “seen” by camera 22 as projected arc 20. The laws of trigonometry dictate that the further a point on the surface of target 10 is away from laser 12, the further to the left in the field of view of camera 22 it will appear. Hence, point Y appears further left than point X. This results from the fact that point Y is further from laser 12 than point X.

If the position of camera 22 is accurately known with respect to laser 12, then the laws of trigonometry may be used to very accurately determine the distance from laser 12 to any point on projected arc 20. These principles are well understood in the prior art. As target object 10 is moved through coherent plane 18, camera 22 will view a whole series of projected arcs 20. These may be recorded and mathematically manipulated to create a surface model of target object 10.

Of course, those skilled in the art will realize that the surface model created is only of the side facing laser 12. A second laser and camera combination is needed to scan the far side of target object 10. Those skilled in the art will also realize that it is difficult to accurately record positions or the upper and lower extremity of target object 10 (because coherent light striking a target object at a small angle of incidence produces very little backscatter). Thus, it is common to have at least three scanners (laser and camera combinations) positioned around the object, separated by 120 degrees.

Computer hardware and software is typically used in conjunction with the ring of scanners to sample positional data at a fixed rate. The scanning system would also include a measurement device for finding the leading edge of target object 10 and for measuring its linear progress in the direction indicated by the arrow in FIG. 3. Thus, the system can compute the linear position along the length of target object 10 for each successive projected are 20 which is sampled by camera 22. The distance from laser 12 to each point on projected arc 20 can be computed using straightforward trigonometry. These sets of surface points can then be employed to create a mathematical surface model of target object 10.

Target object 10 has been represented as a simple cylinder. However, it is important to realize that it can be any three-dimensional shape. The technique disclosed is not dependent upon the shape of the object being scanned. Different shapes will be used for target object 10 throughout this specification.

While the prior art method disclosed is functional it does have several significant drawbacks. First, cylindrical lens 16 must spread coherent beam 14 into coherent plane 18. The result is that the intensity of coherent beam 14 is significantly diminished by virtue of its being spread across an arc.

The speed and accuracy of an optical scanner is significantly dependent on the signal to noise ratio produced by the scanning technique. Ideally, the laser impact on the target object should be much brighter than the ambient lighting. Interference filters are often used on camera 22 in order to increase the signal to noise ratio. An interference filter can be made by stacking a series of dielectric layers having varying indices of diffraction. The thicknesses selected for the alternating layers ideally has the effect of allowing light having a wavelength close to that of laser 12 to pass, while excluding other wavelengths. The result is an increase in the signal to noise ratio of the device.

However, the mechanical structure of such interference filters means that they only work well for light traveling in a direction which is perfectly perpendicular to the orientation of the filter (on-axis, with respect to the filter). The more off-axis the incoming light becomes, the more the wavelength of peak transmission shifts toward the blue end of the spectrum. As a result, interference filters work best with cameras having a narrow field of view. This results from the fact that a camera with a narrow field of view does not sample light which is significantly off the axis of the camera lens (and therefore off the axis of an interference filter placed within the camera lens assembly).

Returning to FIGS. 2 and 3, the user will observe that camera 22 must have a fairly wide field of view in order to encompass all of projected arc 20. The necessity of such a wide field of view means that the interference filters used in camera 22 lose much of their ability to discriminate light having the wavelength of laser 12 from unwanted ambient light. The signal to noise ratio available in the prior art device illustrated in FIGS. 1-3 is therefore limited due to the required wider band-pass filter and the spreading of the laser energy over a wide area.

Those skilled in the art will also realize that target object 10 may have a rough and irregular surface, further diffusing the laser light (This is especially true of target objects such as logs, which have a very rough external surface). The result is that camera 22 will often lose projected arc 20 within the surrounding ambient light. Thus, light-blocking shrouds are often needed, which are very cumbersome in a production line. If the shrouds are not used, then the entire working environment must often be made very dark. This is difficult and potentially dangerous for the persons working on the line.

In addition, the significant angular offset needed between camera 22 and laser 12 introduces mounting and stability concerns. If the two devices vibrate relative to each other, this will introduce an error in the scanned surface model of target object 10. This technique is often used in large production lines with very heavy machinery. Vibration is a significant concern.

The known methods for scanning three-dimensional objects in order to create a map of, their surfaces therefore have the primary limitations of: (1) projecting the coherent light source through an arc, thereby greatly reducing its brightness; and (2) requiring the use of a scanning camera with a relatively wide field of view, significantly reducing the effectiveness of the interference filters used. These limitations reduce the signal to noise ratio available in such scanners, thereby reducing their speed and accuracy.

### BRIEF SUMMARY OF THE INVENTION

Accordingly, the primary object of the present invention is to provide a scanning device with a substantially increased signal to noise ratio. This primary object will be achieved by: (1) projecting the laser on the target object as a single intensely bright point, rather than as an arc; and (2) employing a scanning camera with a narrow field of view so that highly selective interference filters can be used. The present invention also has the following additional objects and advantages:

1. To scan the target object as it moves along at line speed;

2. To eliminate the need for light-blocking shrouds around the target object itself;

3. To eliminate the need for a darkened working area; and

4. To create a scanning device which is less susceptible to vibration.

The fundamental concept of the present invention is that it sweeps a laser beam and the field of view of a line scan video camera across the surface of a target object in synchronization. The synchronization means that the impact point of the laser beam on the target object will lie somewhere within the field of view of the line scan camera. Then, by accurately measuring the position of the laser impact point within the field of view of the line scan camera, trigonometric principles can be applied to calculate the distance from the scanning device to the impact point. A multitude of such impact point measurements can then employed to create a mathematical surface model of the target object.

The illustrations assume that the target object will be moved past the scanning device, such as by an assembly line conveyor. By sweeping the scan up and down the surface of the target object and monitoring the target object's linear progress past the scanning device, the location of numerous points on the surface of the target object can be determined. Conventional mathematical modeling techniques can then be used to develop a three dimensional surface model of the target object. This surface model can then be used to drive a variety of subsequent operations, such as cutting, welding, shaping, etc.

It is important for the reader to realize that the same techniques can be employed by fixing the position of the target object and moving the scanning device relative thereto. Thus, the scope of the invention should not be lied to scanning operations on moving assembly lines.

### BRIEF SUMMARY OF THE SEVERAL VIEWS OF THE DRAWINGS

FIG. 1 is an isometric view, showing a typical prior art device.

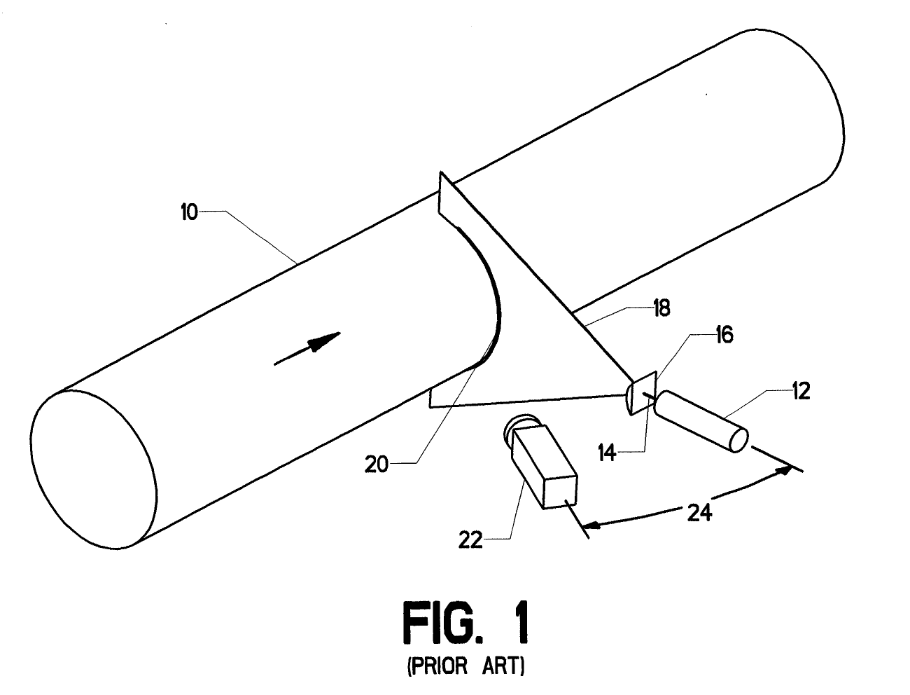

FIG. 2 is an isometric view, showing the same prior art device from a different angle.

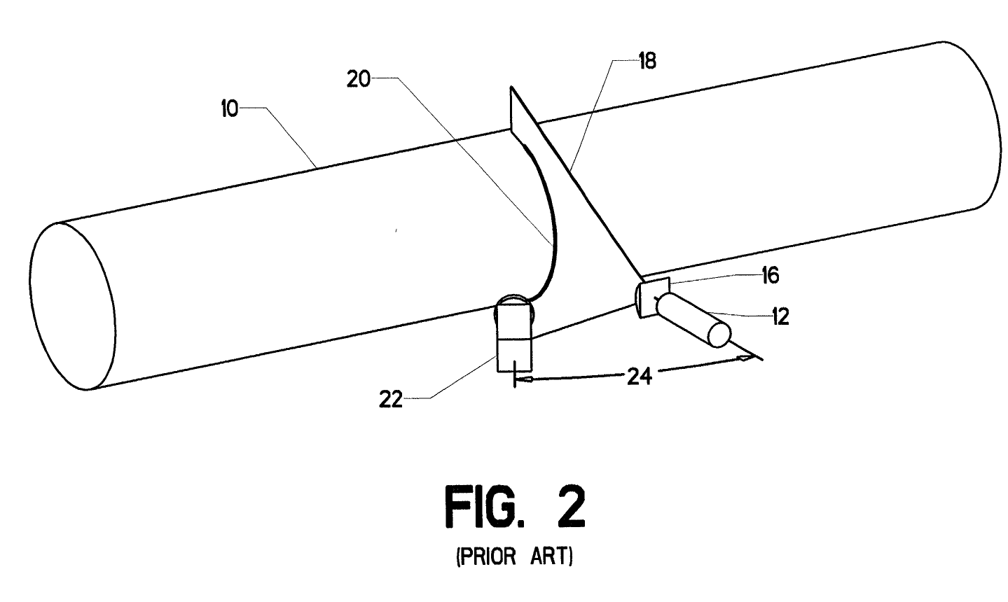

FIG. 3 is an elevation view, showing the view of the camera in the prior art device.

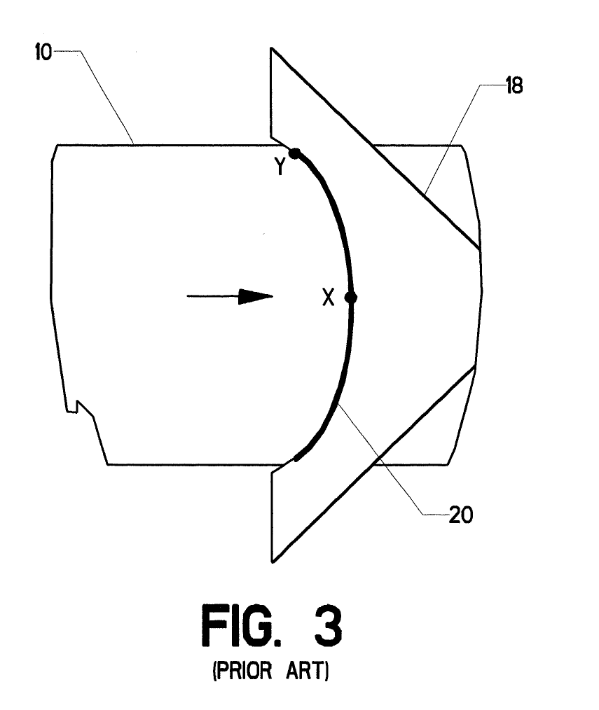

FIG. 4 is an isometric view, showing one embodiment of the proposed invention.

FIG. 5A is an isometric view, showing a more complete view of the proposed invention.

FIG. 5B is an elevation view, showing the view of the line scan camera.

FIG. 5C is an elevation view, showing a target object passing the scanning device.

FIG. 6 is an isometric view, showing a view of the proposed invention from the rear.

FIG. 7 is a plan view, illustrating the trigonometric principles of the proposed invention.

FIG. 8 is an isometric view, illustrating the preferred embodiment of the proposed invention.

FIG. 9 is an isometric view, showing a more complete view of the embodiment seen in FIG. 8.

FIG. 10 is an isometric view, showing a view of the preferred embodiment from the rear.

FIG. 11 is a plan view, illustrating the trigonometric principles of the preferred embodiment.

FIG. 12 is a plan view, showing more detail of he scanning device shown in FIG. 11.

FIG. 13 is an isometric view, illustrating the operation of the preferred embodiment.

FIG. 14 is an isometric view, illustrating the operation of the preferred embodiment.

FIG. 15 is a plan view, illustrating the operation of the preferred embodiment.

FIG. 16 is a plan view, illustrating the operation of the preferred embodiment.

FIG. 17 is an isometric view, illustrating the trajectory of the laser and camera view when the common mirror is deflected fully downward.

FIG. 18 is an isometric view, illustrating some of the principles of optics.

FIG. 19 is an isometric view, illustrating some of the principles of optics.

### REFERENCE NUMERALS IN THE DRAWINGS

10 target object

12 laser

14 beam

16 cylindrical lens

18 coherent plane

20 projected arc

22 camera

24 offset angle

26 line scan camera

28 galvanometer

30 oscillating shaft

32 laser mirror

34 camera mirror

36 camera field of view

38 far extreme distance

40 near extreme distance

42 splitting mirror

44 projector mirror

46 receiver mirror

48 near impact point

50 far impact point

52 separation distance

54 first impact point

56 second impact point

58 target vector

60 width of view

62 sample distance

64 third impact point

66 beam origin point

68 scanning band

70 incident ray

72 reflected ray

74 plane of incidence

76 plane of reflection

78 incident ray projection

80 mirror surface

### DESCRIPTION OF THE INVENTION

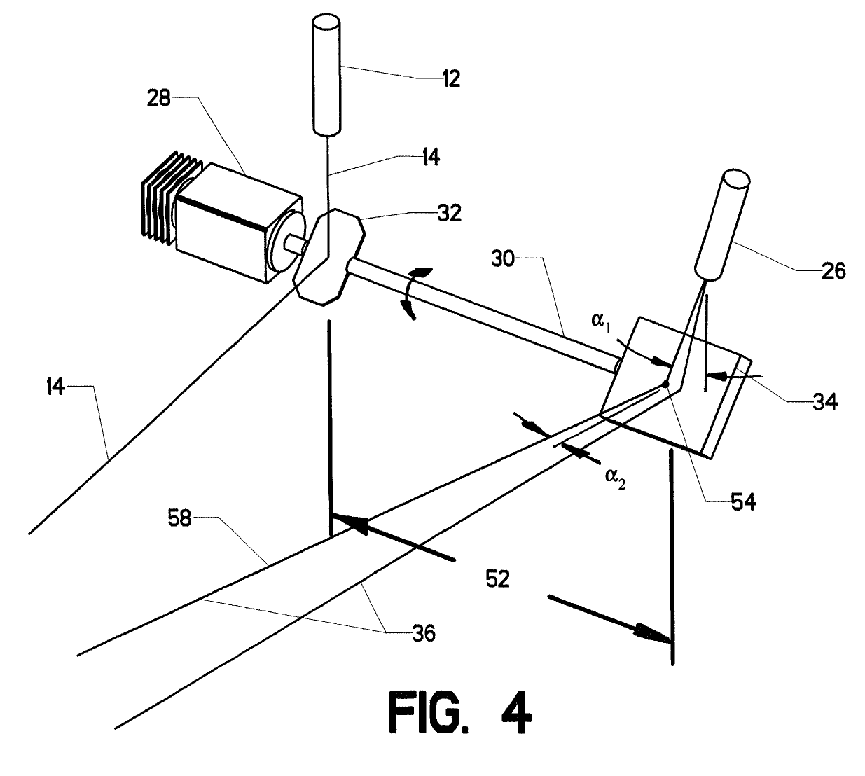

FIG. 4 depicts one embodiment of the present invention. Galvanometer 28 has oscillating shaft 30 extending from one side as shown. Galvanometer 28 is an electrically-activated driving unit. It is typically biased to the neutral position shown. However, galvanometer 28 also has electromagnetic actuators which can cause oscillating shaft 30 to deflect +/−7.5 degrees in a rapid and controlled fashion, as indicated by the reciprocating arrow. The internal details of galvanometer 28 are not significant to the present invention. However, the oscillating motion is significant, irrespective of what device is used to create it.

Laser mirror 32 is fixedly attached to oscillating shaft 30. Laser 12 is positioned above laser mirror 32. It directs beam 14 onto laser mirror 32. Beam 14 is then reflected outward as shown. Camera mirror 34 is also fixedly attached to oscillating shaft 30. It is separated from laser mirror by separation distance 52.

Line scan camera 26 is positioned above camera mirror 34. The reader will observe that line scan camera 26 is tilted relative to laser 12. It points downward onto camera mirror 34, but the aforementioned tilt skews its field of view at an angle relative to the direction of beam 14. Camera field of view 36 is thereby put on an intersecting course with beam 14. The significance of this intersecting course will be explained shortly.

Although persons skilled in the art will understand the term “line scan camera,” a brief explanation may be helpful. The sensing element in most video cameras is comprised of an array of light sensitive cells, commonly called pixels. A typical video camera would have an array of 512 pixels by 512 pixels (X and Y), for a total of 262,144 pixels. The data produced by the camera is often a voltage level for each of these pixels—which corresponds to the light intensity upon that pixel. A line scan camera, in contrast, only has a single line of pixels. A line scan camera corresponding to the visual acuity of the 512×512 conventional camera would have only a single row of 512 pixels (X only).

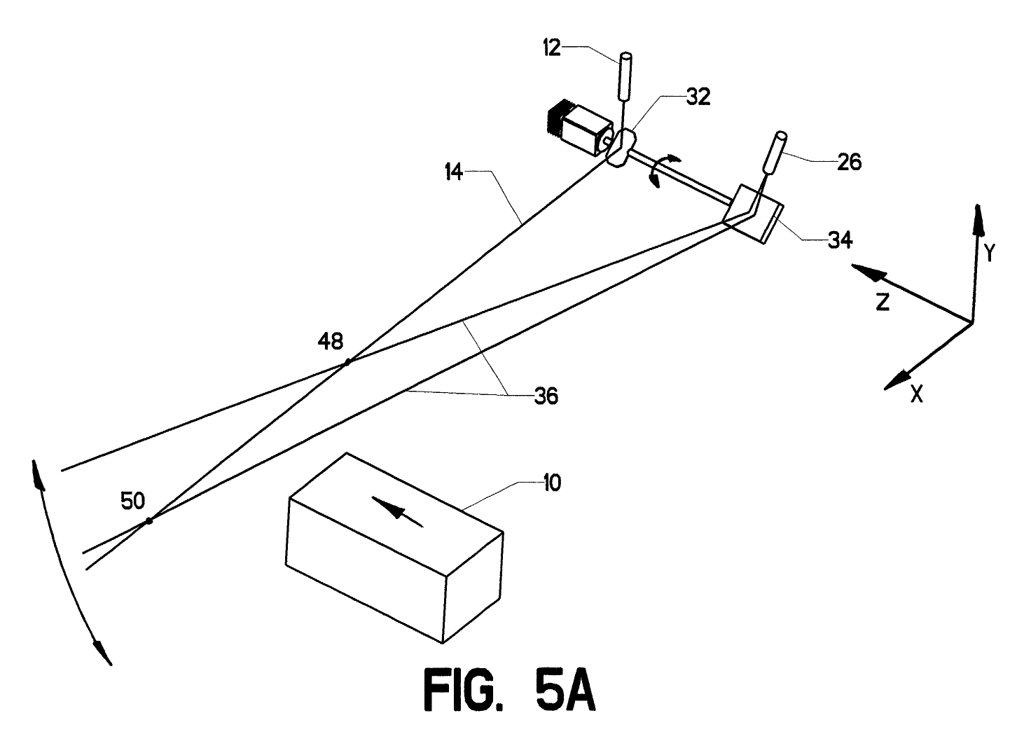

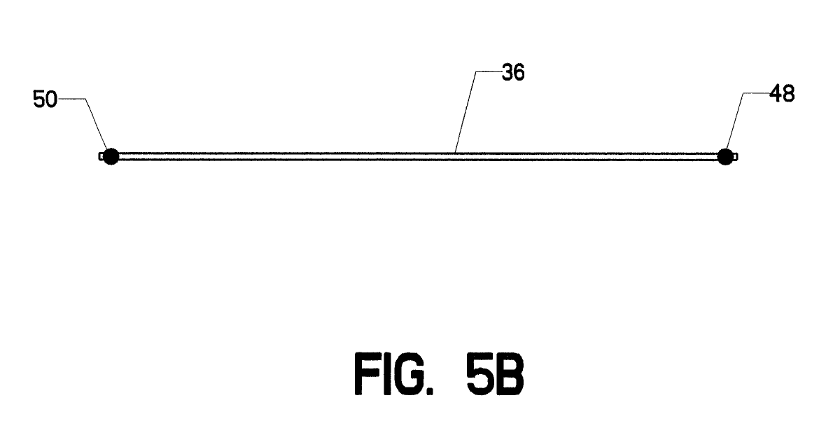

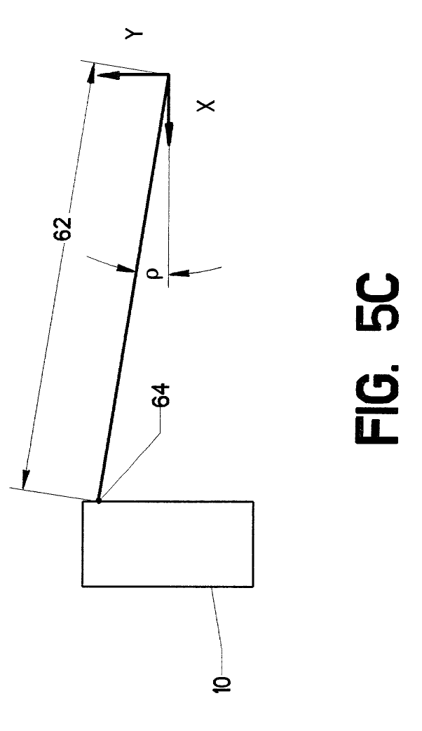

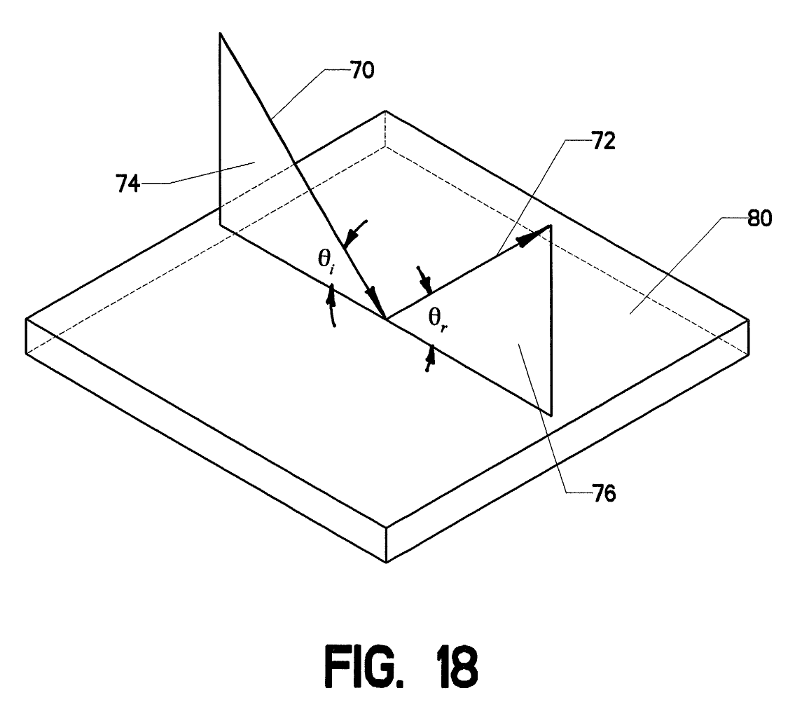

The reader will observe in FIG. 4 that beam 14 is reflected by laser mirror 32. Likewise, camera field of view 36 is reflected by camera mirror 34. Although the geometric principles of light reflection are well known to those skilled in the art, the following brief explanation may prove helpful in further understanding FIGS. 4 and 5. Turning now to FIG. 18, the reader will observe that incident ray 70 strikes mirror surface 80. In this example, incident ray 70 is traveling in a plane which is perpendicular to mirror surface 80, denoted as plane of incidence 74. Incident ray 70 strikes mirror surface 80 and is reflected as reflected ray 72. Since plane of incidence 74 is perpendicular to mirror surface 74, plane of reflection 76 is the same as plane of incidence 74. The angle of reflection, θr, will also be equal to the angle of incidence, θi.

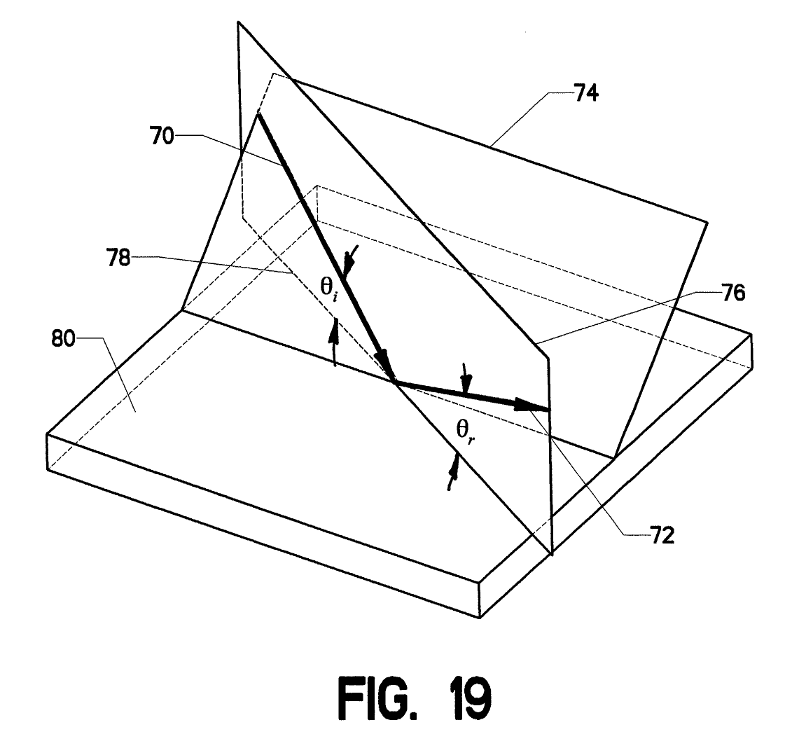

The situation is more complex when incident ray 70 is traveling in a plane which is not perpendicular to mirror surface 80. In FIG. 19, the reader will observe that plane of incidence 74 is not perpendicular to mirror surface 80. However, it is nevertheless very simple to determine the perpendicular projection of incident ray 70 upon mirror surface 80—denoted as incident ray projection 78. Incident ray 70 and incident ray projection 78 then define plane of reflection 76. The angle between incident ray 70 and incident ray projection 78 becomes the angle of incidence, θi. The angle of reflection, θr, must be equal to θi. Reflected ray 72 can then be determined. In this way, a general solution can be obtained for any ray striking a reflected surface at any angle.

Returning now to FIG. 4, the reader will observe that camera field of view 36 extends downward from line scan camera 26. The edges of camera field of view 36 diverge from one another at an angle of 6 degrees (for the particular line scan camera illustrated, which has a 6 degree field of view). Camera mirror 34 provides line scan camera 26 with a view out in the direction of travel of beam 14. The reader will observe that even though the path of light entering line scan camera 26 has been bent approximately 90 degrees by camera mirror 34, the divergence of the edges of camera field of view 36 continues.

The field of view of a conventional video camera (X and Y) is often graphically represented as a cone. The reader will therefore appreciate that the field of view of a line scan camera (X only) is appropriately represented by two diverging lines lying in a single plane, such as shown in FIG. 4.

FIG. 5A shows an expanded view of the same device depicted in FIG. 4. The reader will observe that beam 14 extends outward indefinitely. Being comprised of coherent light, beam 14 will continue on its path until it strikes a target object. A bright point of laser light will then be produced on the target object at this point of impact (“backscatter”). This impact point will be an intensely bright spot. Even if the target object is bathed in significant ambient light (even sunlight), the laser point of impact will be clearly visible.

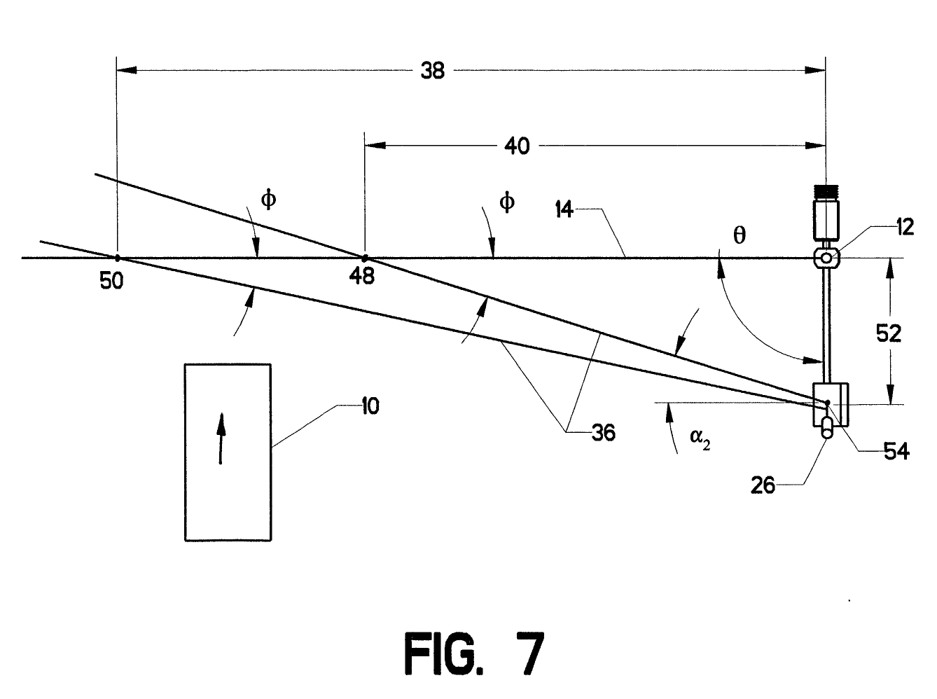

Owing to the aforementioned tilt of line scan camera 26, camera field of view 36 cuts across the path of beam 14. Turning briefly to FIG. 7, the significance of this feature will be explained. FIG. 7 is a plan view of the same device shown in FIGS. 4 and 5A. The reader will observe that the tilt of line scan camera 26 directs camera field of view 36 across the path of beam 14. It would be theoretically possible to eliminate the need for the angular tilt of line scan camera 26 by using a camera with a much wider field of view. However, as explained previously, the use of a narrow field of view is desirable because it allows the use of more efficient interference filters. It also reduces geometric distortion (the “fish-eye” effect) which must be taken into account in the distance calculations. Thus, the tilting of line scan camera 26 is a necessary feature of the embodiment shown.

Returning now to FIG. 5A, the trigonometric principles of the device will be explained. The device is capable of very accurately measuring distances within the range of near impact point 48 and far impact point 50. Although these two impact points will be used as examples, those skilled in the art will readily appreciate that the device can measure an infinite number of points in between impact points 48 and 50, limited only by the spatial resolution of the line scan camera.

If the near surface of the target object is located at near impact point 48, then beam 14 will produce a bright point of laser light at near impact point 48. This point corresponds to one extreme of camera field of view 36. FIG. 5B depicts the actual view of line scan camera 26. As explained previously, camera field of view 36 is a line of pixels (X only). The laser impact point will appear as near impact point 48, at the extreme right hand position of camera field of view 36. As depicted, the field of view of the line scan camera is wide, but not tall. It is therefore critical that the narrow height of the camera field of view intersects the path of beam 14. This goal is accomplished by fixing camera mirror 34 and laser mirror 32 to the same shaft. In this way the laser and the camera scan the target object together.

Returning to FIG. 5A, if the near surface of the target object is located at far impact point 50, then beam 14 will produce a bright point of laser light at far impact point 50. This point corresponds to the other extreme of camera field of view 36. In that case, the laser impact point in FIG. 5B will appear as far impact point 50, at the extreme left hand position of camera field of view 36. Intermediate positions of the target object will obviously correspond to intermediate positions of the bright point within camera field of view 36 on FIG. 5B.

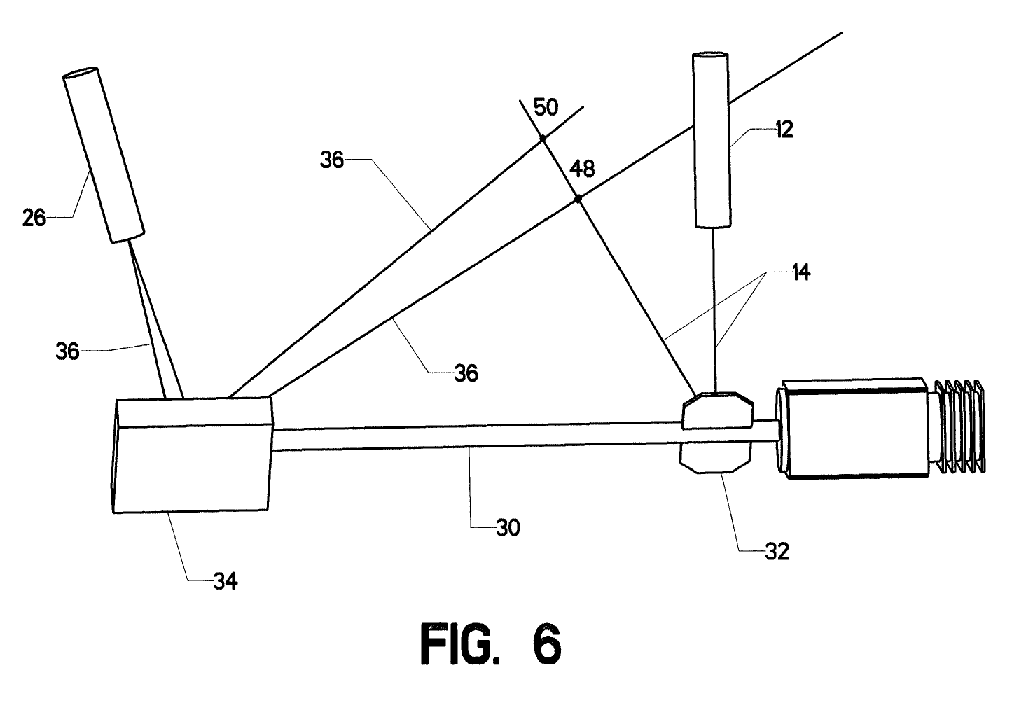

FIG. 6 shows a view from the rear of the scanning device. This view better illustrates how the position of the impact point upon the target object appears within the field of view of line scan camera 26. The further beam 14 travels before striking the target object, the further to the left the bright point will appear in camera field of view 36.

Those skilled in the art will readily appreciate that by knowing the position of the bright point within camera field of view 36 in FIG. 5B, straightforward trigonometry allows the computation of the distance from the scanning device to the target object. These trigonometric principles will be explained, with the initial reference being made to FIG. 4.

As an example, the principles will be explored for an impact point lying at the extreme right hand of camera field of view 36, which corresponds to the line denoted as target vector 58. It is important to realize that the same principles apply to any impact point lying within camera field of view 36.

Knowing the position of the laser impact point within camera field of view 36 allows the computation of the angle α₁. Since the distance between line scan camera 26 and camera mirror 34 is a known (depending on the position of oscillating shaft 30), the angle α₁ can be used to determine the position of first impact point 54 on camera mirror 34. This also allows the computation of the angle of incidence on camera mirror 34. Since the angle of incidence equals the angle of reflection, the angle α₂ can be calculated. Thus, the point of origin (first impact point 54) and the angular heading for target vector 58—which leads to the impact point on the target object—can be determined.

Continuing the same example, and turning now to FIG. 7, the reader will observe that beam 14 is directed outward in a direction perpendicular to oscillating shaft 30. This is represented in the view as the angle θ, which is constant at ninety degrees. Its point of impact on laser mirror 32 is always directly beneath laser 12. In the view shown, the point of origin for beam 14 will therefore be directly beneath laser 12. The point of origin for target vector 58, as explained previously, is first impact point 54. The angular heading of target vector 58 is known to be the angle α₂. It is then a matter of simple trigonometry to determine the value for the angle φ.

Separation distance 52 between the point of origin for beam 14 and first impact point 54 can be calculated, since laser 12 is fixed in position and first impact point 54 has been previously calculated. Having determined the value for separation distance 52 and the angle φ, the distance to the impact point on the target object can be determined. Continuing the present example shown in FIG. 4, the impact point on the target object can be found by finding the intersection of target vector 58 and beam 14. Returning to FIG. 7, the intersection will be near impact point 48. The distance to that point will then be near extreme distance 40.

The same process can be employed to calculate the distance to any impact point between near impact point 48 and far impact point 50. It is this calculation of distance which comprises the device's critical function. The device is essentially a very accurate range finder.

Numerous computations are obviously required to determine the distance to the target object. This task is performed by monitoring the output of line scan camera 26 with a digital computer. Returning briefly to FIG. 5B, the user will appreciate that the position of the bright point along camera field of view 36 will correspond to digital data output. The computer scans this output to update the position of the bright point and compute the distance to the target object.

Returning now to FIG. 4, the function of galvanometer 28 will be explained in greater detail. Galvanometer 28 drives oscillating shaft 30 through periodic oscillations of +/−7.5 degrees. These oscillations are performed at a regulated rate, such as 60 Hz. Since laser mirror 32 and camera mirror 34 are attached to oscillating shaft 30, they oscillate in synchronization. Thus, laser mirror 32 and camera mirror 34 both oscillate through arcs of +/−7.5 degrees. The result is that beam 14 and camera field of view 36 oscillate through arcs of +/−15 degrees (The fact that the angle of reflection must be equal to the angle of incidence means that when the mirror moves −7.5 degrees, the reflected rays must move −15 degrees).

Turning now to FIG. 5A, the reader will observe that the oscillation of oscillating shaft 30 means that beam 14 and the plane of camera field of view 36 move up and down in synchronization ( as shown by the reciprocating arrow). This vertical oscillation means that the scanning device actually measures a series of impact points along a vertical line on the near surface of the target object. Target object 10 is typically moved into the path of beam 14, in the direction indicated. Its forward motion is continued as the oscillation of oscillating shaft 30 is continued. Thus, the scanning device is “walking” the beam up and down the near surface of the advancing target object 10. The digital computer is used to take regular samples and compute the distance to each sampled point.

Turning to FIG. 5C, the digital computer can also be used to monitor the position of oscillating shaft 30, denoted as the angle ρ. In this view the origin of the coordinate system is placed on the centerline of oscillating shaft 30 (oscillating shaft 30, the two mirrors, and the galvanometer are not shown for visual simplicity). Knowing sample distance 62 to sample impact point 64, as well as the angle ρ, allows the computation of sample impact point 64's position in terms of the X and Y coordinates shown in FIG. 5C.

Another sensor can be employed to accurately monitor the linear progress of target object 10 as it proceeds past the scanning device. Turning back to FIG. 5A, this additional sensory input allows the computer to determine the location of a particular impact point in the Z direction. The location of a whole series of points on the near surface of target object 10 can therefore be determined in X, Y, and Z coordinates. Mathematical modeling techniques can then be employed to create a detailed surface model of the near surface of target object 10 from the sample points. It is assumed that target object 10 is moving in a strictly linear fashion, such as on a conveyor belt. However, as explained previously, the same principles can be used where target object 10 remains fixed and the scanning device is moved in a controlled fashion.

Of course, just as for prior art scanners, the embodiment disclosed can only map the portion of target object 10 that it “sees.” It is difficult for the scanning device to sample more than 120 degrees around the circumference of a target object. Thus, a ring of three or more scanning devices would typically be employed to map the target object on all sides.

The primary novel feature of the present invention is the synchronized motion of beam 14 and camera field of view 36. This feature means that beam 14 does not need to be spread by a cylindrical lens or other means. The intensity of its impact upon target object 10 is therefore not reduced. The synchronized scanning also allows the use of a line scan camera with a relatively narrow field of view. This means that highly efficient interference filters can be used to attenuate unwanted ambient light. The result is that the embodiment shown in FIG. 5A can achieve a significantly greater signal to noise ratio than prior art devices. It is therefore significantly less prone to errors induced by ambient light.

It is important to realize that computation speed is critical in many scanning operations. The target object must be scanned and mapped while it is moving at line speed. As soon as the target object has been accurately mapped, the map is used to drive other machinery which cuts, welds, or shapes the object (among many other possibilities). The present invention's increase in signal to noise ratio—with consequent increases in scanning accuracy and speed—allows a more accurate model to be created in less time.

Returning briefly to FIG. 4, those skilled in the art will realize that separation distance 52 is critical to the accuracy of the device. Increasing the value for separation distance 52 increases the parallax effect seen at line scan camera 26. This phenomenon is particularly apparent in FIGS. 6 and 7. The larger the value for separation distance 52, the larger the variation of the laser impact point within camera field of view 36 for a given change in distance from the scanning device to the laser impact point. Unfortunately, however, it is impractical to greatly increase separation distance 52 in the embodiment shown. Looking particularly at FIG. 6, the reader will observe that oscillating shaft 30 is long and relatively slender. Laser mirror 32 and camera mirror 34 represent significant oscillating masses. If high speed scanning is desired, it may be necessary to rotate oscillating shaft 30 at a rate of 100 Hz or more. This results in significant vibrational energy.

Those skilled in the art will realize that asymmetric forces will tend to bend and flex oscillating shaft 30 at the higher frequencies. Additional journal bearings can be used to stabilize the assembly, but the mechanical forces and resulting vibration will significantly erode the accuracy of the device. In addition, the energy requirements for driving the device increase significantly as oscillating shaft 30 grows longer. Accordingly, it is highly desirable to obtain an increased parallax effect at line scan camera 26 without the need for lengthening oscillating shaft 30.

Preferred Embodiment

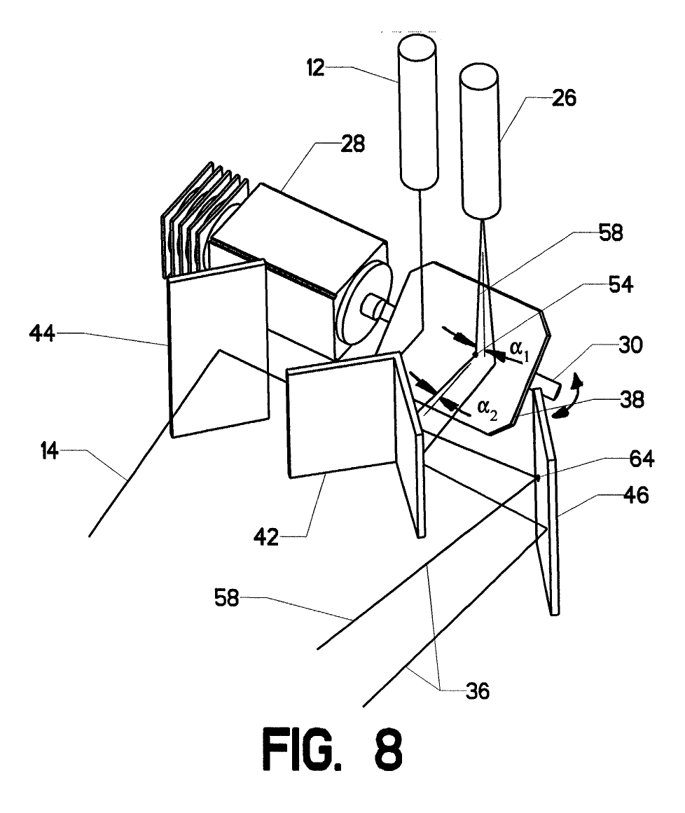

FIG. 8 depicts a second embodiment which solves this concern. Because of this advantage, FIG. 8 represents the preferred embodiment. Galvanometer 28 is identical to the one disclosed in FIG. 4. However, oscillating shaft 30 has been significantly shortened. A single common mirror 38 is attached to oscillating shaft 30. Laser 12 and line scan camera 26 are placed close together, directly above common mirror 38. The reader will also observe that line scan camera 26 is no longer tilted relative to laser 12.

The distance between laser 12 and line scan camera 26 in this case is insufficient to obtain the desired parallax effect and desired scanning accuracy. Another technique is therefore employed to effectively increase this distance. As beam 14 and camera field of view 36 are reflected away from common mirror 38, they encounter splitting mirror 42. Beam 14 is reflected to the left, and camera field of view 36 is reflected to the right. Beam 14 is then reflected again out toward the target object by projector mirror 44. Likewise, camera field of view 36 is reflected out toward the target object by receiver mirror 46. The particular line scan camera 26 has a 6 degree field of view—the same field of view as the line scan camera disclosed in FIGS. 4-7.

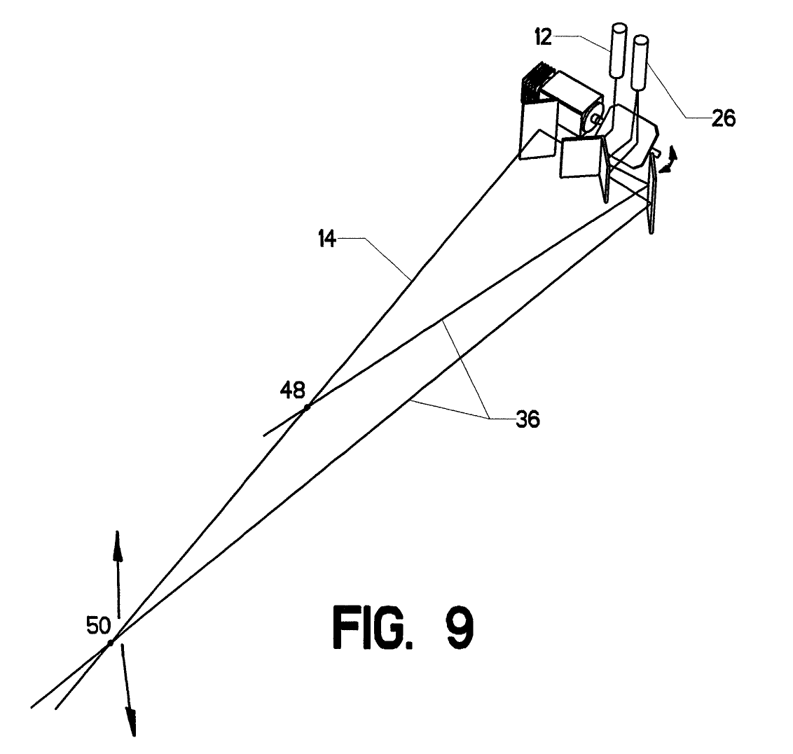

FIG. 9 shows a larger view of the same apparatus. Beam 14 is projected across the planar camera field of view 36. Just as in FIG. 5A, the range in which distances may be measured is denoted by near impact point 48 and far impact point 50. The operation of the device is very similar to the first embodiment disclosed in FIGS. 4 through 7. Oscillating shaft 30 moves through an arc of +/−7.5 degrees, as shown by the reciprocating arrow. This allows the device to sample many points along the near surface of the target object.

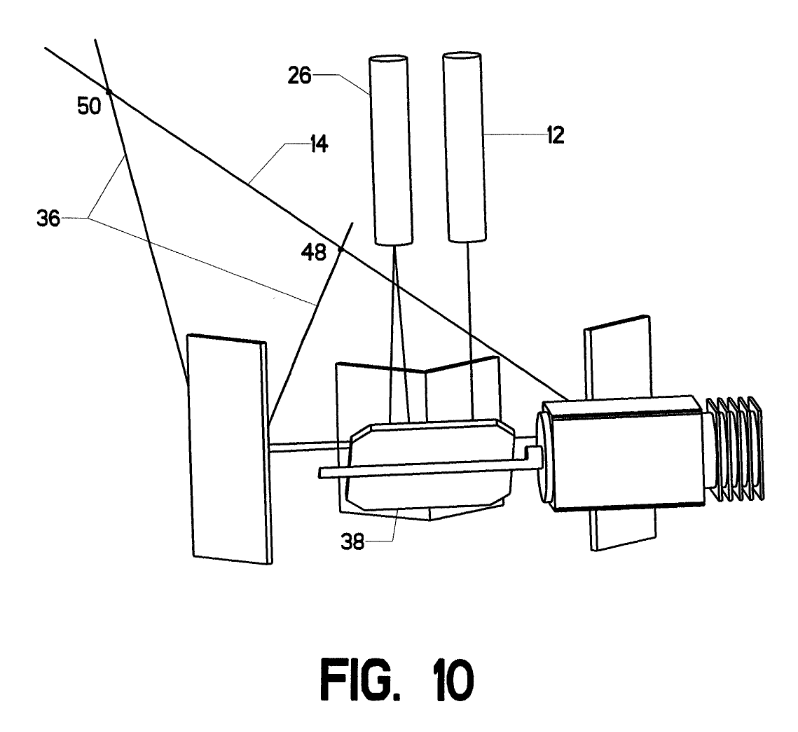

FIG. 10 shows a rear view of the preferred embodiment. The reader will in this view readily observe how beam 14 cuts across the planar camera field of view 36. Again, this view better illustrates how the position of the impact point upon the target object appears within the field of view of line scan camera 26. The further beam 14 travels before striking the target object, the further to the left the bright point will appear in camera field of view 36. Thus, far impact point 50 appears further to the left than near impact point 48.

Just like in the version described in FIGS. 4 through 7, calculating the distance to the impact point in the preferred embodiment is simply a matter of trigonometry. However, as more mirrors and reflections are involved, one can easily appreciate that the trigonometry will be more complex. Turning back to FIG. 8, another example will be employed to step through the computation process. Assume that the bright impact point of the laser on the target object appears at the extreme right hand of camera field of view 36. This will correspond to the extreme labeled as target vector 58 in the view. The reader will observe that target vector 58 has four portions: (1) the portion from line scan camera 26 to common mirror 38; (2) the portion from common mirror 38 to splitting mirror 42; (3) the portion from splitting mirror 42 to receiver mirror 46; and (4) the portion from receiver mirror 46 out to the target object. In order to determine the location in space for the impact point upon the target object, a step-wise process must be employed.

The angle α₁ is known from the position of the bright point observed by line scan camera 26. The distance between line scan camera 26 and common mirror 38 is also known (for a given position of oscillating shaft 30). First impact point 54 may therefore be calculated. This point becomes the point of origin for the second leg of target vector 58. Since the angle of incidence equals the angle of reflection for common mirror 38, the angular heading of this second leg can also be calculated. This is denoted as the angle α₂.

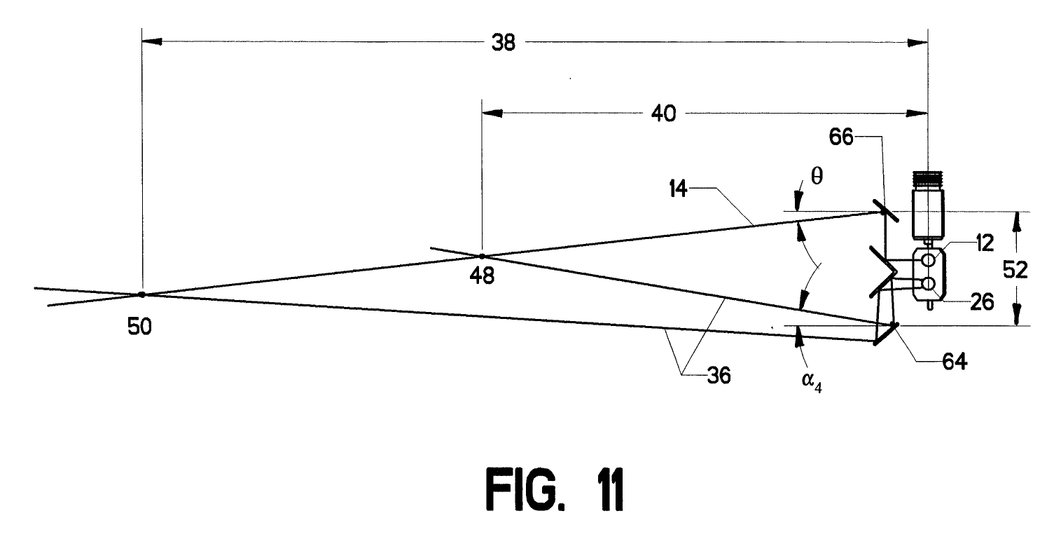

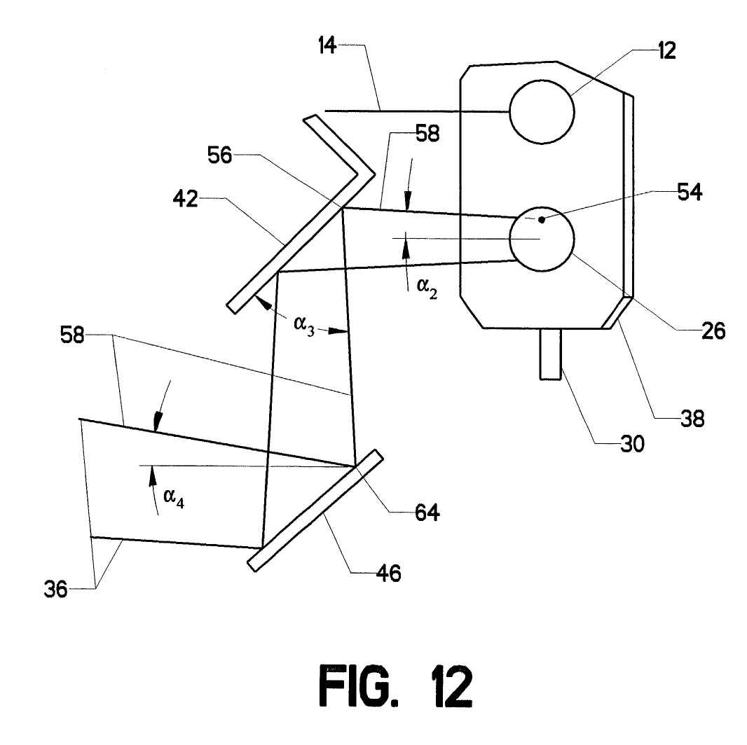

FIG. 8 shows oscillating shaft 30 in its neutral position; i.e., at an angle of 45 degrees with respect to beam 14 coming out of laser 12. This is a convenient position for illustration, because all of the trigonometry calculations can be performed in the plane of the plan view (realizing that when oscillating shaft 30 moves off the neutral position, both beam 14 and camera field of view 36 are projected out of the plane of the plan view). Such a plan view is shown in FIG. 11. A close-up of the device is shown in FIG. 12.

Splitting mirror 42 and receiver mirror 46 are fixed in position with respect to each other and with respect to common mirror 38 (for a given position of oscillating shaft 30). Knowing first impact point 54 and the angle α₂ therefore allows the calculation of second impact point 56. This then becomes the point of origin for the third portion of target vector 58. Again using the optical law that the angle of incidence equals the angle of reflection allows the computation of the angle α₃. This, in turn, allows the determination of third impact point 64. Applying the same optical law allows the computation of the angle α₄.

Thus, the point of origin and angular heading for the final portion of target vector 58 can be determined. This information is then used to find the intersection point of this portion with the path of beam 14. Turning back to FIG. 11, this intersection point will be near impact point 48. The distance from the scanning device to this impact point will correspond to near extreme distance 40. Again, it is important to realize that the same process can be used to solve for the distance of a point lying anywhere within camera field of view 36.

The angular computations illustrated in FIG. 12 are relatively simple, because beam 14 and camera field of view 36 both lie within the plan view when oscillating shaft 30 is in the neutral position. Of course, as explained previously, oscillating shaft 30 continuously moves through an arc of +/−7.5 degrees. This oscillating is required to “walk” the range finding function up and down the side of the target object. The oscillation is graphically depicted by the arrows in FIG. 9. Just like in the example illustrated in FIG. 5C, the fact that beam 14 and camera field of view 36 “walk” up and down the side of the target object allows the scanning device to measure the distance to a whole series of impact points within that vertical plane. Like in FIG. 5A, the target object is moved linearly past the scanning device, which allows scanning in a whole series of vertical planes. This data set can then be used to mathematically create a three dimensional surface model of the target object. However, it is important to realize that the oscillation adds another layer of complexity to the trigonometric calculations.

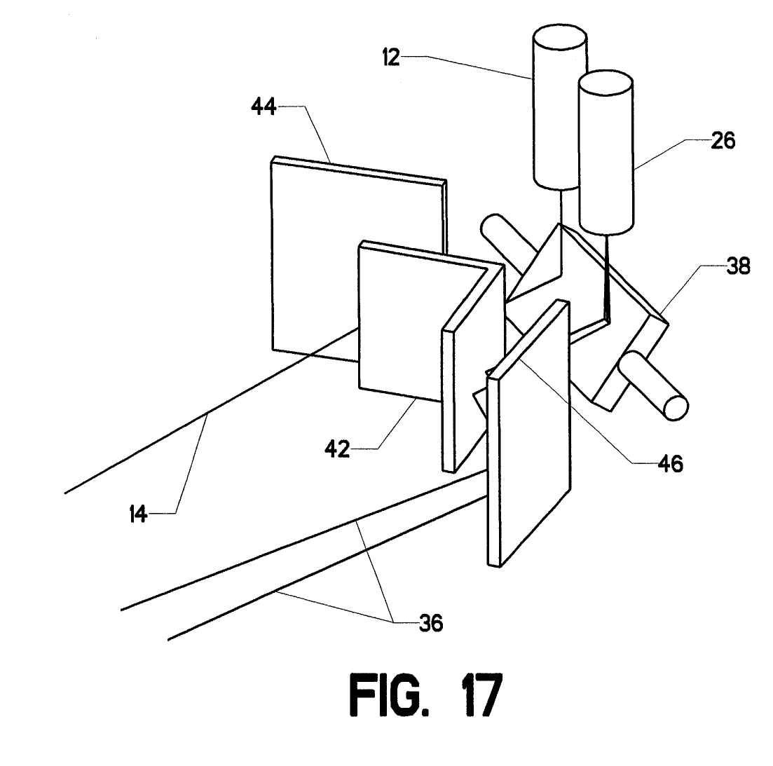

FIG. 17 shows oscillating shaft 30 and common mirror 38 in the −7.5 degree position (the galvanometer has not been shown in order to simplify the view). The reader will readily observe that beam 14 and camera field of view 36 are projected downward. While this fact does make the previously-explained calculations more complex, they may nonetheless be solved using the same optical law that the angle of incidence equals the angle of reflection. It is therefore possible to solve for the vector leading to the impact point on the target object for any position of the galvanometer.

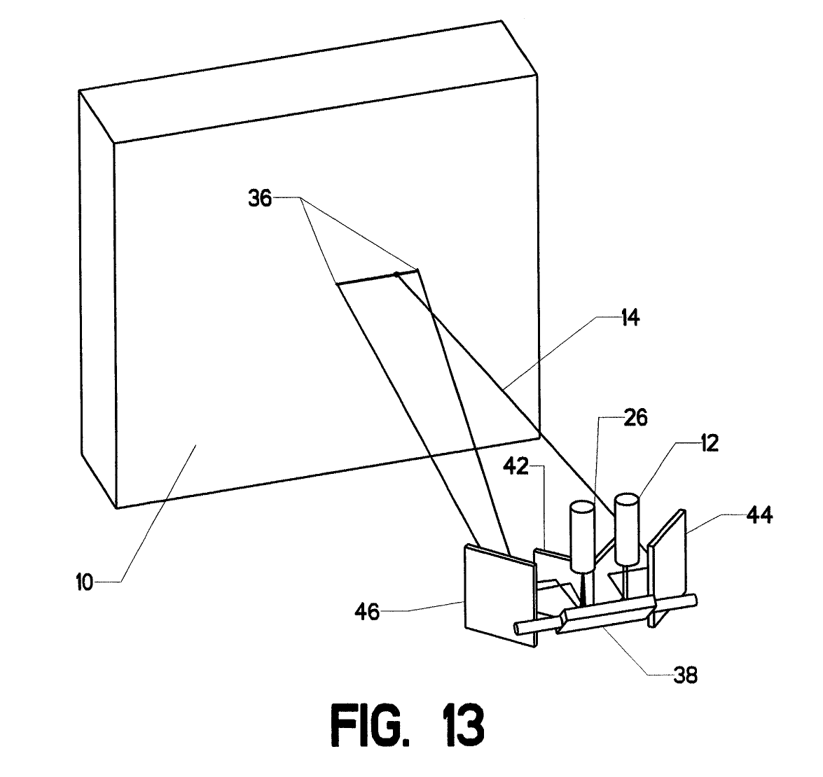

However, an additional layer of complexity should be addressed in order to facilitate a complete understanding of the device's operation. FIG. 13 shows a simplified representation of the scanning device projecting beam 14 onto the near surface of target object 10 (Once again, although target object 10 is shown as being geometrically simple, it could be any three-dimensional shape). Common mirror 38 is shown in the neutral position (which results in beam 14 and camera field of view 36 being projected straight out toward the target). If common mirror 38 is rotated in the negative direction, the projection of camera field of view 36 on target object 10 will travel downward. The projection will in fact continue traveling downward until common mirror 38 reaches its maximum negative deflection (−7.5 degrees).

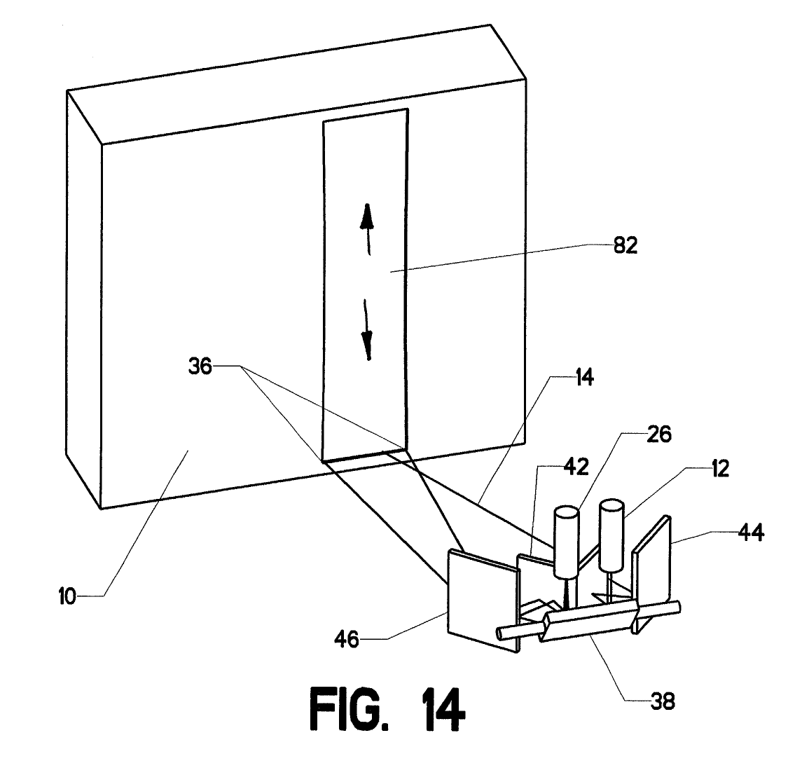

FIG. 14 shows common mirror 38 at the point of maximum negative deflection. The reader will note that beam 14 and the plane of camera field of view 36 have moved as far down on target object 10 as they can go. If common mirror 38 is oscillated through its full range of motion, camera field of view 36 and beam 14 will move up and down on target object 10, as shown by the reciprocating arrow. The result will be the creation of sweep area 82.

Those skilled in the art will realize that the vertical boundaries of sweep area 82 are not vertical lines. Instead, sweep area 82 has a slight hour-glass shape. This results from the fact that the projection of camera field of view 36 on target object 10 is wider at the +7.5 degree and −7.5 degree positions of common mirror 38 than it is for the neutral position. The explanation for this phenomenon is simple: The distance from the scanning device to the target object is shortest in the neutral position, since both beam 14 and camera field of view 36 strike the target object perpendicularly. As common mirror 38 is moved off the neutral position, the distance to the point of impact on the target object increases (graphically visible in comparing FIGS. 13 and 14).

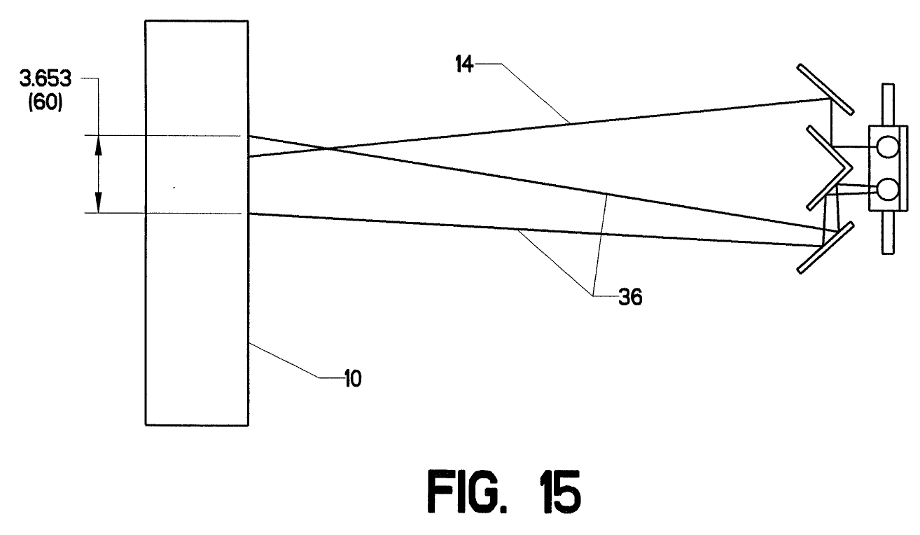

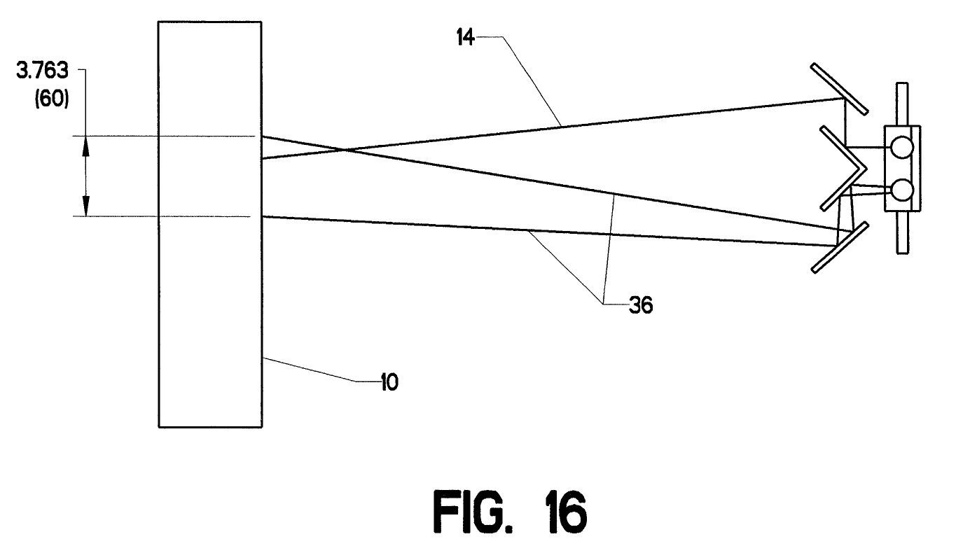

FIGS. 15 and 16 further illustrate this principle. FIG. 15 shows common mirror 38 in the neutral position. The reader will observe that beam 14 and camera field of view 36 fall upon target object 10. Width of view 60 indicates the width of camera field of view 36 at the point where it falls upon target object 10. For this particular line scan camera, width of view 60 equals 3.653 inches.

FIG. 16 shows common mirror 38 in the −7.5 degree position. Target object 10 remains in the same position. The reader will observe that width of view 60 is now equal to 3.763 inches, thus proving that the width of the projected field of view increases as common mirror 38 is moved away from the neutral position. It is important to realize that the numbers themselves are only important in the sense that they prove the concept of the hour-glass shaped scanning band 68.

This phenomenon is sometimes known as “pin-cushioning.” It is typical of the geometric distortions which must be accounted for in designing a scanning device. The computations performed must account for the hour-glass shape in order to achieve maximum accuracy. Take, as an example, a target object having a flat planar surface facing the scanning device. Target object 10 shown in FIGS. 13 and 14 does, in fact, have a flat planar surface facing the scanning device. The computations must account for the fact that the distance from the scanning device to the impact point on the target object is greater in FIG. 14 than in FIG. 13, even though a perfectly flat surface is being scanned. It is simple to account for this factor by using a polar coordinate system centered on oscillating shaft 30. If such a coordinate system is employed, the coordinates of any impact point on the target object can be expressed in terms of a distance and an angular position with respect to oscillating shaft 30. The Z coordinate (as referenced in FIG. 5A) is then obtained by measuring the linear progress of target object 10 past the scanner.

It is possible to write a series of trigonometric equations that solves for the position of any target impact point given the inputs of (1) the position of oscillating shaft 30; (2) the position of the impact point on the target object within camera field of view 36; and (3) the linear position of the target object as it progresses past the scanner. One really only needs to understand the optical principle that the angle of incidence equals the angle of reflection. However, while these principles are important to a thorough understanding of the physics of the device, one seeking to use the device need not understand them.

Instead, the range finding function of the device can be implemented via experimental calibration. The calibration starts by setting and locking the position of oscillating shaft 30. A target object is then placed within camera field of view 36. The distance from a reference point on the scanning device (such as the centerline of oscillating shaft 30) to the impact point on the target object is then mechanically measured and recorded. The position of the impact point within the field of view of the line scan camera is also carefully measured and recorded. These two values can then be projected as an X-Y plot, with one value on the X axis and the other value on the Y axis. A whole series of such measurements can be made and recorded for different distances. A polynomial can then be fitted through the resulting data, thereby providing a mathematical expression which solves for target distance on the basis of the position of the impact point within the field of view of the line scan camera

An additional series of measurements can be taken for different angular positions of oscillating shaft 30. A polynomial can then be created for each angular position. These polynomials are then stored in a digital computer.

The set of polynomials can be used to compute a distance to the impact point for a given position of the impact point within the field of view of the line scan camera and a given position of oscillating shaft 30. It is even possible to create a single curve-fitting polynomial which works for all positions of oscillating shaft 30. Thus, given the inputs of the position of oscillating shaft 30 and the position of the impact point within the field of view of the line scan camera, the single polynomial can be used to compute the distance from the scanning device to that impact point. While this calibration process sounds somewhat complex, those skilled in the art will readily appreciate that it is easily automated using computer software. And, once the geometry of the scanning device is set by the initial design, the calibration need only be performed once.

Summary, Ramifications, and Scope

Accordingly, the reader will appreciate that the proposed invention can accurately measure the distance to a plurality of points on the surface of a target object, thereby allowing the creation of a three-dimensional surface model of that object. The invention has further advantages in that it:

1. Greatly increases the signal to noise ratio with respect to prior art devices;

2. scans the target object as it moves along at line speed;

3. eliminates the need for light-blocking shrouds;

4. eliminates the need for a darkened working area; and

5. is less susceptible to vibration induced error.

Although the preceding description contains significant detail, it should not be construed as limiting the scope of the invention but rather as providing illustrations of the preferred embodiment of the invention. Thus, the scope of the invention should be fixed by the following claims, rather than by the examples given.

Having described our invention, we claim:

1. A device for determining the distance from a fixed position to a plurality of points on the surface of a target object, comprising:
a. a laser, positioned proximate said fixed position, with its beam directed toward said target object so as to create an impact point on said target object;
b. a video camera, positioned proximate said laser, and fixed in position with respect to said laser, with the field of view of said video camera directed toward said impact point on said target object;
c. measurement means capable of accurately measuring the position of said impact point within said field of view of said video camera;
d. computation means for calculating the distance from said fixed position to said impact point on the basis of said measured position of said impact point within said field of view of said video camera; and
e. oscillation means for oscillating said beam and said video camera field of view in synchronization so as to sweep said beam of said laser and said field of view of said camera across said target object while maintaining said impact point within said field of view of said video camera, so as to permit the computation of distances for a plurality of said impact points on said target object.

2. A device as recited in claim 1 wherein said video camera is a line scan camera.

3. A device as recited in claim 1, further comprising memory means for storing said computed distances to said impact points in order to create a surface model of said target object.

4. A device for determining the distance from a fixed position to a plurality of points on the surface of a target object, comprising:
a. a laser, positioned proximate said fixed position, with its beam not directed toward said target object;
b. a video camera, positioned proximate said laser, and fixed in position with respect to said laser, with the field of view of said video camera pointed in the same direction as said beam;
c. a galvanometer, having an oscillating shaft extending therefrom, and being positioned proximate said laser, with said oscillating shaft being oriented to obstruct the path of said beam and said field of view of said camera;
d. a mirror, fixedly attached to said oscillating shaft, and positioned so as to reflect said beam and said camera field of view out toward said target object, so that said beam creates an impact point on said target object which falls within said field of view of said camera, and so that an oscillation of said oscillating shaft causes the oscillation of said mirror, thereby causing said impact point and said camera field of view to sweep across said target object in synchronization;
e. measurement means capable of accurately measuring the position of said impact point within said field of view of said video camera; and
f. computation means for calculating the distance from said fixed position to said impact point on the basis of said measured position of said impact point within said field of view of said video camera.

5. A device as recited in claim 4 wherein said video camera is a line scan camera.

6. A device as recited in claim 5, further comprising memory means for storing said computed distances to said impact points in order to create a surface model of said target object.

7. A device for determining the distance from a fixed position to a plurality of points on the surface of a target object, comprising:
a. a laser mirror;
b. a camera mirror, offset a set separation distance from said laser mirror, and linked to said laser mirror so as to move in unison with said laser mirror;
c. a laser, positioned so as to direct a beam upon said laser mirror and from thence out to said target object;
d. a camera, positioned so as to view the impact point of said beam upon said target object through its reflection in said camera mirror;
e. means for oscillating said laser mirror through a set arc, thereby moving said impact point of said beam up and down upon said target object, and also moving said camera mirror in unison with said laser mirror so that said impact point is always within the field of view of said camera;
f. means for measuring the position of said impact point within said field of view of said camera; and
g. computation means for calculating the distance from said shaft to said impact point using said set separation distance and said position of said impact point within said field of view of said camera.

8. The device as recited in claim 7, further comprising memory storage means so as to record a plurality of computed distance measurements in order to build a mathematical profile of said target object.

9. The device as in claim 8 wherein said target object is moved past said laser mirror in a controlled fashion and wherein the linear motion of said target object is sensed by sensing means so that a plurality of said mathematical profiles of said target object can be computed, thereby allowing the computation of a full surface mode.

10. A device for determining the distance from a fixed position to a plurality of points on the surface of a target object, comprising:
a. a common mirror;
b. a laser, positioned so as to direct a beam upon said common mirror and from thence out to said target object
c. a camera, offset a set distance from said laser, and positioned so as to view the impact point of said beam upon said target object through its reflection in said common mirror;
d. means for oscillating said common mirror through a set arc, thereby moving said impact point of said beam up and down upon said target object, and also moving the field of view of said camera in unison with said impact point so that said impact point is always within said field of view of said camera;
e. means for measuring the position of said impact point within said field of view of said camera; and
f. computation means for calculating the distance from said shaft to said impact point using said set separation distance and said position of said impact point within said field of view of said camera.

11. A device for determining the distance from a fixed position to a plurality of points on the surface of a target object, comprising:
a. a common mirror;
b. a splitting mirror, having a first angled side and a second angled side;
c. a projector mirror, offset a set distance from said first angled side of said splitting mirror;
d. a receiver mirror, offset a set distance from said second angled side of said splitting mirror;
e. a laser, positioned so as to direct a beam upon said common mirror and from thence upon said first angled side of said splitting mirror, and from thence upon said projector mirror, and from thence out to said target object
f. a camera, positioned so as to view the impact point of said beam upon said target object through its reflection in said receiver mirror, said second angled side of said splitting mirror, and said common mirror;
g. means for oscillating said common mirror through a set arc, thereby moving said impact point of said beam up and down upon said target object, and also moving the field of view of said camera in unison with said impact point so that said impact point is always within said field of view of said camera;
h. means for measuring the position of said impact point within said field of view of said camera; and
i. computation means for calculating the distance from said shaft to said impact point using said set separation distance and said position of said impact point within said field of view of said camera.
